(19) United States
(12) Patent Application Publication
(10) Pub. No.: US 2011/0122159 A1
(43) Pub. Date: May 26, 2011

(54) METHODS, DEVICES, AND COMPUTER PROGRAM PRODUCTS FOR PROVIDING MULTI-REGION TOUCH SCROLLING

(75) Inventors: Jonas Bergsten, Malmo (SE); Jenny Fredriksson, Malmo (SE); Samuel Sjöblom, Malmo (SE)

(73) Assignee: Sony Ericsson Mobile Communications AB

(21) Appl. No.: 12/622,814

(22) Filed: Nov. 20, 2009

(51) Int. Cl. G09G 5/00; G06F 3/041; G06F 3/048

(52) U.S. Cl. 345/684; 345/173; 715/830

(57) ABSTRACT

An electronic device includes a user interface and a processor coupled thereto. The user interface includes a display screen operable to display text and/or graphics, and a touch-sensitive interface comprising an array of sensors operable to receive a scrolling input from a user input object and generate a touch signal in response thereto. The processor is operable to detect the scrolling input and a location on the touch-sensitive interface at which the scrolling input was received responsive to the touch signal, and to scroll a different amount of the text and/or graphics on the display screen responsive to the scrolling input and according to the detected location. Related devices and methods of operation are also discussed.

### FIELD

The present invention relates to electronic devices and, more particularly, to electronic devices with touch-sensitive user interfaces and related methods of operation.

### BACKGROUND

Electronic devices such as handheld and/or desktop computing devices are continuing to evolve to provide increasing functionality. Consumers may now select from a wide array of handheld and/or desktop electronic devices, such as cellular mobile terminals. personal digital assistants (PDAs), laptop computers, and desktop computers. Such devices typically provide audio and/or video user interfaces. For example, a mobile terminal may include a display, keypad, speaker and microphone, which together support telephony functions. These components may also support multimedia, gaming and other applications.

Producers of such devices constantly strive to provide new audio and visual interfaces to enhance user experience and, thus, garner greater market share. For example, handheld and desktop devices have been provided with touchscreen displays that may allow for user scrolling and other inputs using a user input object, such a finger or thumb. However, when scrolling in a relatively long list of entries (such as a contact list on a mobile phone) responsive to a user touch input, there may be problems with speed and/or accuracy. For example, if there are several hundred entries in the list, several touch inputs may be required to scroll to a desired entry, which may take a relatively long time. Conversely, an on-screen scrollbar may be used to scroll through the large portions of the list more quickly, but at the expense of accuracy, as a relatively small touch input may represent a large portion of the list.

### SUMMARY

According to some embodiments of the present invention, an electronic device includes a processor and a user interface coupled thereto. The user interface includes a display screen operable to display text and/or graphics, and a touch-sensitive interface including an array of sensors operable to receive a scrolling input from a user input object and generate a touch signal in response thereto. The processor is operable to detect the scrolling input and a location on the touch-sensitive interface at which the scrolling input was received responsive to the touch signal, and to scroll a different amount of the text and/or graphics on the display screen responsive to the scrolling input and according to the detected location.

In some embodiments, the touch-sensitive interface may include first and second regions. The processor may be operable to scroll a first amount of the text and/or graphics on the display screen responsive to detection of the scrolling input at the first region, and may be operable to scroll a second amount of the text and/or graphics that is less than the first amount on the display screen responsive to detection of the same scrolling input at the second region.

In some embodiments, the processor may be operable to detect a distance of movement of the scrolling input on the touch-sensitive interface responsive to the touch signal, to correlate the distance of movement to the first amount of the text and/or graphics according to a first sensitivity ratio responsive to detection of the scrolling input at the first region, and to correlate the distance of movement to the second amount of the text and/or graphics according to a second sensitivity ratio responsive to detection of the same scrolling input at the second region.

In some embodiments, the first sensitivity ratio may associate a scrollable area of the first region with a first percentage of the text and/or graphics, and the second sensitivity ratio may associate a scrollable area of the second region with a second percentage of the text and/or graphics that is less than the first percentage. As such, the distance of movement of the scrolling input may represent a greater amount of the text and/or graphics responsive to detection thereof at the first region than at the second region.

In some embodiments, the first sensitivity ratio may associate a scrollable area of the first region with an entirety of the text and/or graphics, and the second sensitivity ratio may associate a scrollable area of the second region with a fraction of the text and/or graphics. As such, the processor may be operable to scroll less than or up to the entirety of the text and/or graphics responsive to detection of the scrolling input at the first region, and the processor may be operable to preclude scrolling of more than the fraction of the text and/or graphics responsive to detection of the same scrolling input at the second region.

In some embodiments, the processor may be operable to scroll the first amount of the text and/or graphics on the display screen at a greater scrolling speed than the second amount of the text and/or graphics.

In some embodiments, the text and/or graphics may be a plurality of alphanumeric entries. The processor may be operable to highlight a first character of one of the plurality of entries that is currently displayed on the display screen responsive to detection of the scrolling input at the first region. The processor may also be operable to detect a transition input indicating movement of the user input object from the first region to the second region responsive to the touch signal, and to highlight on the display screen a second or subsequent character of the currently displayed one of the plurality of entries responsive to detection of the transition input. The processor may be further operable to scroll only ones of the plurality of entries having the same first character as the displayed one of the plurality of entries responsive to detection of the scrolling input at the second region subsequent to detection of the transition input.

In some embodiments, the second region may be immediately adjacent to the first region on the touch-sensitive interface such that the touch-sensitive interface may be operable to receive the scrolling input at the first and/or second regions without lifting of the user input object from the touch-sensitive interface.

In some embodiments, the first and second regions may have different x-coordinates along an x-axis of the touch-sensitive interface so that the first and second regions provide first and second columns on the touch-sensitive interface. The scrolling input may have substantially similar y-coordinates along a y-axis of the touch sensitive interface within the first or second column.

In some embodiments, the touch sensitive interface may further include a third region. The processor may be operable to scroll a third amount of the text and/or graphics that is less than the second amount on the display screen responsive to detection of the same scrolling input at the third region.

In some embodiments, ones of the array of sensors underlying the first region may be operable to generate a different touch signal responsive to receiving the scrolling input than ones of the array of sensors underlying the second region.

In some embodiments, ones of the array of sensors underlying the first region may be a greater in number than ones of the array of sensors underlying the second region.

In some embodiments, the display screen may be provided underlying the touch sensitive interface such that the user interface comprises a touch screen display.

According to further embodiments of the present invention, in a method of operating an electronic device to control scrolling of text and/or graphics on a display screen thereof, a scrolling input is received from a user input object at a touch-sensitive interface of the electronic device. A touch signal is generated responsive to receiving the scrolling input at the touch-sensitive interface. The scrolling input and a location on the touch-sensitive interface at which the scrolling input was received is detected responsive to the touch signal, and a different amount of the text and/or graphics is scrolled on the display screen responsive to detecting the scrolling input and according to the detected location.

In some embodiments, the touch-sensitive interface may include first and second regions. A first amount of the text and/or graphics may be scrolled on the display screen responsive to detecting the scrolling input at the first region, and a second amount of the text and/or graphics that is less than the first amount may be scrolled on the display screen responsive to detecting the same scrolling input at the second region.

In some embodiments, a distance of movement of the scrolling input on the touch-sensitive interface may be detected responsive to the touch signal. The distance of movement may be correlated to the first amount of the text and/or graphics according to a first sensitivity ratio responsive to detection of the scrolling input at the first region, and the distance of movement may be correlated to the second amount of the text and/or graphics according to a second sensitivity ratio responsive to detection of the same scrolling input at the second region.

In some embodiments, the first amount of the text and/or graphics may be scrolled on the display screen at a greater scrolling speed than the second amount of the text and/or graphics.

Other electronic devices, methods, and/or computer program products according to embodiments of the invention will be or become apparent to one with skill in the art upon review of the following drawings and detailed description. It is intended that all such additional electronic devices, methods, and/or computer program products, as well as any and all combinations of the above embodiments, be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a schematic block diagram illustrating an electronic device including a touch-sensitive interface that provides multi-region touch scrolling in accordance with some embodiments of the present invention;

FIGS. 2A and 2B illustrate example mobile terminals including respective touch-sensitive interfaces that provide multi-region touch scrolling in accordance with some embodiments of the present invention;

FIGS. 3A and 3B illustrate touchscreen displays having multiple touch-sensitive regions in accordance with some embodiments of the present invention;

FIGS. 4A to 4E illustrates multi-region touch scrolling in a touchscreen display having multiple touch-sensitive regions in accordance with some embodiments of the present invention; and

FIG. 5 is a flow diagram illustrating an example control sequence for operating an electronic device to provide multi-region touch scrolling of text and/or graphics on a display screen in accordance with some embodiments of the present invention.

### DETAILED DESCRIPTION OF EMBODIMENTS

The present invention now will be described more fully hereinafter with reference to the accompanying figures, in which embodiments are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” (and variants thereof) when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element/step (and variants thereof), it can be directly responsive to the other element/step, or intervening elements/steps may be present. In contrast, when an element/step is referred to as being “directly responsive” to another element/step (and variants thereof), there are no intervening elements/steps present. As used herein the term “and/or” includes any and all combinations of one or more of the associated listed items and may be abbreviated as “/”.

It will be understood that, although the terms first, second, third, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by hardware and/or in software (including firmware, resident software, micro-code, etc.), referred to herein as “circuitry” or “circuit”. For example, some of the functionality may be implemented in computer program instructions that may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks. The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

A computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Although some of the diagrams include arrows on communication paths to show a primary direction of communication, it is to be understood that communication may occur in the opposite direction to the depicted arrows.

For purposes of illustration and explanation only, various embodiments of the present invention are described herein primarily in the context of mobile terminals including touchscreen displays; however, it will be understood that the present invention is not limited to such embodiments and may be embodied generally in any system that employs a touch-sensitive user interface. As used herein, a “touch-sensitive interface” may refer to an electronic input device, such as a touchscreen, that is configured to detect touch and/or motion-based user inputs on an area within which the sensor is bounded. As such, touch sensitive interfaces as described herein do not encompass button, toggle, or other physical switch-type interfaces. Although described herein primarily with reference to capacitance-based touch sensitive interfaces, it is to be understood that some embodiments of the present invention may employ one or more other touch sensing technologies, such as resistance, surface acoustic wave (SAW), infrared, strain gauge, optical imaging, dispersive signal, acoustic pulse imaging, frustrated total internal reflection, and/or other touch sensing technologies.

As used herein, “scrolling” refers to sliding text, images or video across a display screen, from top-to-bottom, bottom-to-top, left-to-right, or right-to-left. “Scrolling” does not change the layout of the text or graphics, but rather, incrementally moves portions of a larger image into and/or out of the user's view on the display screen, where the entirety of the larger image is not viewable on the display screen at a present level of magnification. Also, a “scrolling input” refers to movement of a user input object on a touch-sensitive interface from top-to-bottom, bottom-to-top, left-to-right, right-to-left, or diagonally between the aforementioned directions. The direction, speed, and/or amount of scrolling may be based on the direction, speed, and/or distance of the scrolling input on the display screen, respectively. As used herein, an “amount of scrolling” refers to the portion or percentage of the larger image that is moved across the display screen in response to a scrolling input, while a “speed of scrolling” or “scrolling speed” refers to the relative rate at which the portions of the larger image are moved across the display screen in response to a scrolling input.

Some embodiments of the present invention arise from realization that, for a relatively long text and/or graphics file (such as a list of entries) that is not viewable in its entirety on a display screen, scrolling a fixed or same amount of the list responsive to each user touch input may allow for relatively high accuracy in scrolling at the expense of speed in navigating the list. Accordingly, some embodiments of the present invention provide different amounts and/or speeds of scrolling based on the location on the touch-sensitive interface at which the scrolling input is received. In particular, a touch-sensitive interface may include multiple regions, each having a different level of sensitivity or responsiveness to a received scrolling input, such that the distance of movement of the scrolling input on the touch-sensitive interface represents a different amount of the text and/or graphics to be scrolled depending on the region at which the scrolling input is received. For example, a relatively small movement received at a higher-sensitivity region may result in scrolling of a greater portion of the text and/or graphics than a similar movement received at the lower-sensitivity region. As such, the percentage of the text and/or graphics that is scrolled on the display screen may be dependent on the location on the touch-sensitive interface at which the scrolling input is received, to improve both navigation speed (responsive to scrolling inputs at the higher-sensitivity region) and scrolling accuracy (responsive to scrolling inputs at the lower-sensitivity region).

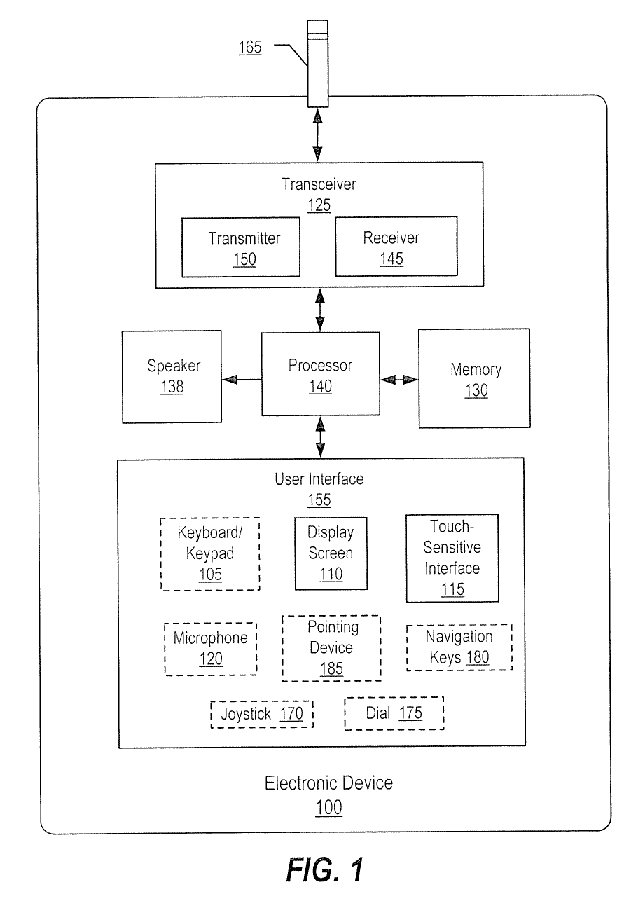

FIG. 1 is a block diagram illustrating an electronic device with multi-region touch scrolling in accordance with some embodiments of the present invention. Referring now to FIG. 1, an exemplary electronic device 100 includes a transceiver 125, memory 130, a speaker 138, a processor 140, and a user interface 155. The transceiver 125 typically includes a transmitter circuit 150 and a receiver circuit 145 that cooperate to transmit and receive radio frequency signals to and from base station transceivers via an antenna 165. The radio frequency signals transmitted between the electronic device 100 and the base station transceivers may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver 125 may include an infrared (IR), Bluetooth, and/or Wi-Fi transceiver configured to transmit/receive signals to/from other electronic devices.

The memory 130 may represent a hierarchy of memory that may include volatile and/or non-volatile memory, such as removable flash, magnetic, and/or optical rewritable non-volatile memory. The memory 130 may be configured to store several categories of software, such as an operating system, applications programs, and input/output (I/O) device drivers. The operating system may control the management and/or operation of system resources and may coordinate execution of programs by the processor 140. The I/O device drivers typically include software routines accessed through the operating system by the application programs to communicate with input/output devices, such as those included in the user interface 155 and/or other components of the memory 130.

The processor 140 is coupled to the transceiver 125, the memory 130, the speaker 138, and the user interface 155. The processor 140 may be, for example, a commercially available or custom microprocessor that is configured to coordinate and manage operations of the transceiver 125, the memory 130, the speaker 138, and/or the user interface 155.

The user interface 155 may include a microphone 120, a display screen 110 (such as a liquid crystal display), a touch sensitive interface 115, a joystick 170, a keyboard/keypad 105, a dial 175, directional navigation key(s) 180, and/or a pointing device 185 (such as a mouse, trackball, etc.). However, depending on functionalities offered by the electronic device 100, additional and/or fewer elements of the user interface 155 may actually be provided. For instance, the touch sensitive interface 115 may be implemented as an overlay on the display screen 110 to provide a touch-sensitive display screen (or “touch screen”) in some embodiments. More generally, while particular functionalities are shown in particular blocks by way of illustration, functionalities of different blocks and/or portions thereof may be combined, divided, and/or eliminated.

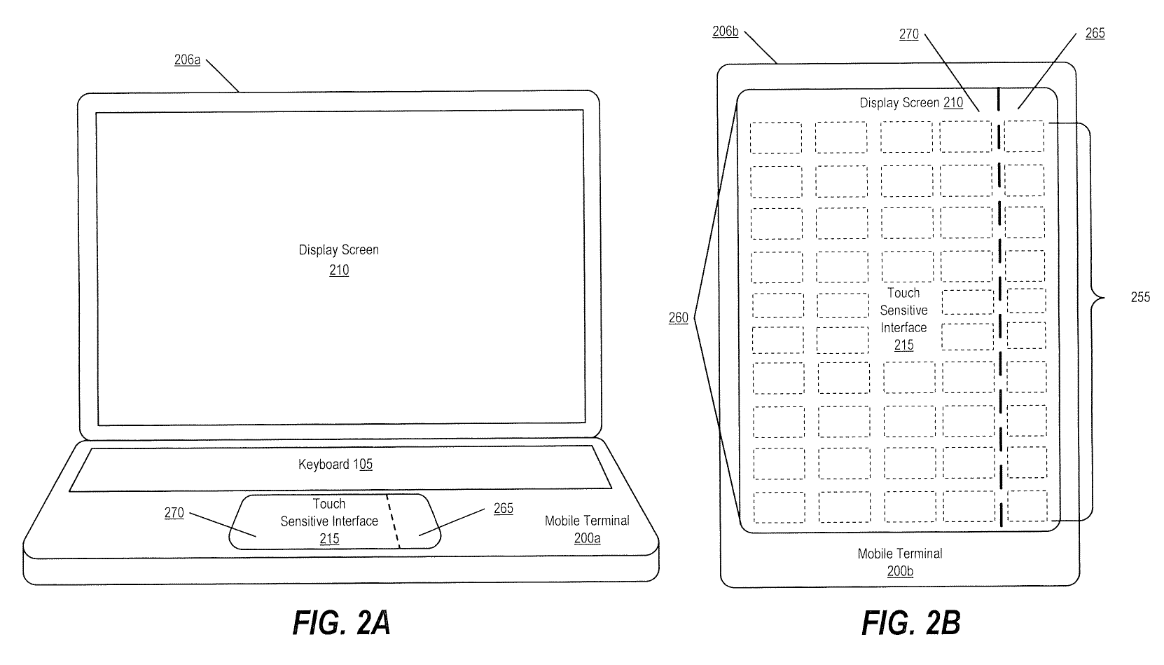

FIGS. 2A and 2B illustrate example configurations of electronic devices (such as the electronic device 100 of FIG. 1) that provide multi-region touch scrolling in accordance with some embodiments of the present invention. As such, the user interfaces and/or other elements of FIGS. 2A and/or 2B may be similar to the user interface 155 and/or other elements of FIG. 1. In particular, FIG. 2A illustrates a mobile terminal 200a (shown as a laptop computer) where the user interface is implemented as a separate keyboard 205, display screen 210, and touch sensitive interface 215 in a housing 206a, while FIG. 2B illustrates a mobile terminal 200b (shown as a mobile phone) where the user interface is implemented as a display screen 210 underlying a touch sensitive interface 215 to provide a touch screen display 260 in a housing 206b.

Referring now to FIGS. 2A and 2B, the touch-sensitive interface 215 includes an array of sensors 255 that are operable to receive a scrolling input from a user input object and generate a touch signal in response to the scrolling input. In particular, the array of touch sensors 255 may be operable to detect the touch and/or directional movements of a user input object, such as a stylus or digit of a human hand (i.e., a thumb or finger) on the touch-sensitive interface 215. The touch signal generated by the sensors 255 may also be used to identify the corresponding location(s) (e.g., coordinate locations) of the touch-sensitive interface 215 at which the input is received (e.g., where a user is touching the touch-sensitive interface 215), the distance of movement of the user input object on the touch-sensitive interface 215, and/or the speed of movement of the user input object.

The touch-sensitive interface also includes a first region 265 and a second region 270. While a dashed line is shown in FIGS. 2A and 2B to differentiate the first region 265 and the second region 270 for purposes of illustration, it will be understood that there may be no visual separation or visual distinction between the first and second regions 265 and 270 in some embodiments. A processor included in the mobile terminal 200a and/or 200b (such as the processor 140 of FIG. 1) may be operable to detect a scrolling input received at the first or second region 265 and 270 based on the touch signal(s) provided by particular ones of the sensors 255 underlying the first and second regions 265 and 270 and interpret the scrolling input differently depending on the region at which it was received. In some embodiments, the processor may detect the location at which the scrolling input is received on the touch-sensitive interface 215 based on known coordinates of the sensor(s) 255 from which the touch signal is received. In additional or alternative embodiments, ones of the sensors 255 underlying the first region 265 may generate a touch signal of a different type or magnitude in response to the scrolling input than ones of the sensors 255 underlying the second region 270, and the processor may detect the scrolling input at the first region 265 and/or the second region 270 in response to the different touch signals. In further additional or alternative embodiments, different types or numbers of the sensors 255 may be provided in the first and second regions 265 and 270 to differentiate the touch signals generated thereby in response to a scrolling input. Thus, the processor may determine the location of at which a scrolling input is received on the touch-sensitive interface 215 responsive to the touch signals.

Still referring to FIGS. 2A and 2B, the processor is operable to provide a different amount of scrolling of the text and/or graphics shown on the display screen 210 in response to the same scrolling input (e.g., a scrolling input having similar characteristics, such as length, direction, duration, speed, etc.), based on the detected location on the touch-sensitive interface 215 at which the scrolling input is received. For example, the processor may detect a distance of movement of the scrolling input on the touch sensitive interface 215 based on the touch signal (for example, by calculating the difference between the starting point and ending point of the user input object), and may correlate the detected distance to a greater amount of the text and/or graphics to be scrolled responsive to detecting the scrolling input at the first region 265 than at the second region 270. The processor may also detect a speed of movement of the scrolling input, and may correlate the detected speed to a greater speed for scrolling the text and/or graphics responsive to detecting the scrolling input at the first region 265 than at the second region 270. As such, the processor associates scrolling and/or other inputs received at the first region 265 of the touch sensitive interface 215 with a greater degree of responsiveness or sensitivity than inputs received at the second region 270.

In some embodiments, the processor may correlate the detected distance of movement of the user input object on the touch-sensitive interface 215 according to different sensitivity ratios depending on whether the scrolling input is detected at the first region 265 or at the second region 270. The sensitivity ratios may associate respective scrollable areas of the first and second region with different percentages of a displayed document. As such, a scrollable area of the first region 265 may represent a greater percentage of a displayed document than the scrollable area in the second region 270. For example, the first region 265 may have a 1:1 sensitivity ratio that associates the scrollable area of the first region 265 with an entirety (e.g., 100%) of the document, while the second region 270 may have a 4:1 sensitivity ratio that associates the scrollable area in the second region 270 with a fraction (for example, about 25%) of the displayed document. The processor may further determine the distance of the scrolling input relative to the scrollable area of the first and second regions 265 and 270, and may thereby relate the distance of the scrolling input to different amounts of scrolling based on whether the scrolling input is detected at the first region 265 or the second region 270. For example, detection of a relatively short scrolling input in the first region 265 (for instance, having a distance of about 25% of the first scrollable area) may provide scrolling of about 25% of the displayed document, while detection of a similar scrolling input in the second region 270 (e.g., having a distance of about 25% of the second scrollable area) may provide scrolling of about 6.25% of the displayed document. Likewise, detection of a scrolling input having a distance approximately equal to the first scrollable area may provide scrolling of the entire document when detected in the first region 265, while detection of four (4) of such scrolling inputs in the second scrollable area may be required to scroll through the entire document when detected in the second region 270. Thus, a scrolling input of a given distance of movement provides a greater amount of scrolling when detected at the first region 265 than when detected at the second region 270.

As such, a scrolling input may allow for scrolling of up to the entirety of the document or less when detected at the first region 265, while the same scrolling input may allow for scrolling of up to only a fraction of the document (and thus, may preclude scrolling of more than the fraction of the document) when detected at the second region 270. Consequently, a user may navigate through a relatively long document at a greater speed by providing scrolling inputs at the first region 265 rather than at the second region 270. Conversely, a user may more precisely navigate through a portion of the document at a slower speed by providing scrolling inputs at the second region 270 rather than at the first region 265. The speed of scrolling of the text and/or graphics on the display screen 210 may also be varied based on the detected speed of movement of the user input object that defines the scrolling input in some embodiments. However, some embodiments of the present invention may provide a faster scrolling speed in response to detecting scrolling inputs in the first region 265 than in response to detecting scrolling inputs in the second region 270 independent or regardless of the detected speed or rate of the scrolling input.

In addition, scrolling inputs may be received at both the first region 265 and the second region 270 substantially simultaneously, and the amount and/or speed of scrolling may be varied based on the combination of scrolling inputs. For example, where scrolling inputs received at the first region 265 are associated with a scrolling speed that is twice the scrolling speed associated with scrolling inputs received at the second region 270, the combination of scrolling inputs may provide an additive or multiplicative effect on the scrolling speed of the text and/or graphics in response to detection of the scrolling inputs at the first and second regions 265 and 270 substantially simultaneously.

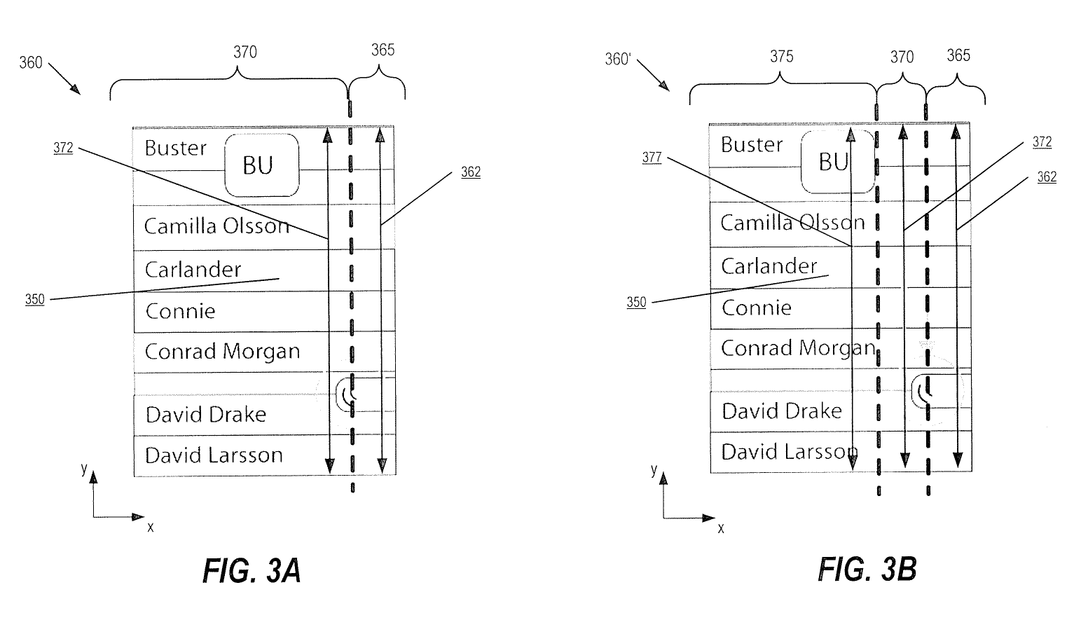

FIGS. 3A and 3B illustrate examples of touch screen displays 360 and 360′ according to some embodiments of the present invention. The touch screens 360 and/or 360′ may be similar to the touch screen 260 described above with reference to FIG. 2B. As shown in FIG. 3A, the touch screen 360 includes a first region 365 having a first scrollable area 362 on the right side of the touch screen display 360, and a second region 370 having a second scrollable area 372 to the left of the first region 365. As such, the first and second regions 365 and 370 have different x-coordinates along an x-axis of the touch screen 360, defining first and second columns on the touch screen 360. The scrolling inputs provided by moving a user input object within the scrollable lengths 362 and 372 have substantially similar y-coordinates along a y-axis of the touch screen 360 within the first and/or second columns. The touch screen 360′ of FIG. 3B further includes a third region 375 having a third scrollable area 377 to the left of the second region 370, where the first, second, and third regions 365, 370, and 375 have different x-coordinates along the x-axis of the touch screen 360′, thereby defining first, second, and third columns on the touch screen 360′.

Accordingly, scrolling inputs received at different locations along the x-axis of the touch screens 360 and/or 360′ may be interpreted differently by a processor (such as the processor 140 of FIG. 1) to provide different amounts of scrolling of a displayed list of alphanumeric entries 350 (illustrated in FIGS. 3A and 3B as a contact list). In particular, as discussed above with reference to the first and second regions 265 and 270 of FIGS. 2A and 2B, each of the regions 365, 370, and 375 may be associated with a different sensitivity ratio relating the respective scrollable areas 362, 372, and 377 with different percentages of the displayed list 350. As such, moving a user input object from top to bottom of the scrollable area 362 in the first region 365 provides scrolling of nearly an entirety of the displayed list 350. In contrast, moving the user input object by a similar distance in the second region 370 (e.g., from top to bottom of the scrollable area 372) provides scrolling of only a portion or a fraction (for example, about one-fourth) of the list 350. Accordingly, a user may quickly find a desired approximate position in the list 350 by scrolling with a finger or other user input object in the higher-sensitivity scrolling region 365 to the right side of the touch screen 360, and, when more detailed scrolling is desired, the user may move the finger to the left into the lower sensitivity scrolling region 370 of the touch screen 360 for more accurate scrolling. Moving the user input object from top to bottom of the scrollable area 377 in the third region 375 may provide scrolling of an even smaller portion (for example, about one-tenth) of the list 350. As the first, second, and third regions 365, 370, and/or 375 are immediately adjacent one another on the touch screens 360 and/or 360′, the user may transition between the first and second regions 365 and 370 or between the second and third regions 370 and 375 when scrolling without lifting the finger or other user input object from the surface of the touch screen 360 or 360′, and thus, can find a desired list entry with a single movement.

Also, scrolling inputs may be received substantially simultaneously in two or more of the first, second, and third regions 365, 370, and 375 using multiple user input objects, and the scrolling inputs may be interpreted in combination to further vary the amount and/or speed of scrolling. In particular, a user may scroll substantially simultaneously in both the second region 370 and the third region 375 using two fingers, where the second and third regions 370 and 375 are associated with different scrolling speeds and/or different amounts of the list 350. In response to detection of the scrolling inputs in both the second and third regions 370 and 375 at the same time, the processor may additively or multiplicatively combine the scrolling speeds and/or amounts of the list 350 associated with each of the regions 370 and 375, and may provide an amount and/or speed of scrolling in accordance with the combination. For example, where the second region 370 is associated with a ‘level 4’ scrolling speed and the third region 375 is associated with a ‘level 2’ scrolling speed, simultaneous scrolling inputs in the second and third regions 370 and 375 would provide scrolling of the list 350 at a ‘level 6’ scrolling speed. Likewise, where the scrollable area 372 of the second region 370 is associated with about 25% of the list 350 and the scrollable area 377 of the third region 375 is associated with about 10% of the list 350, simultaneous scrolling inputs from top to bottom of the scrollable areas in the second and third regions 370 and 375 would provide scrolling of about 35% of the list 350.

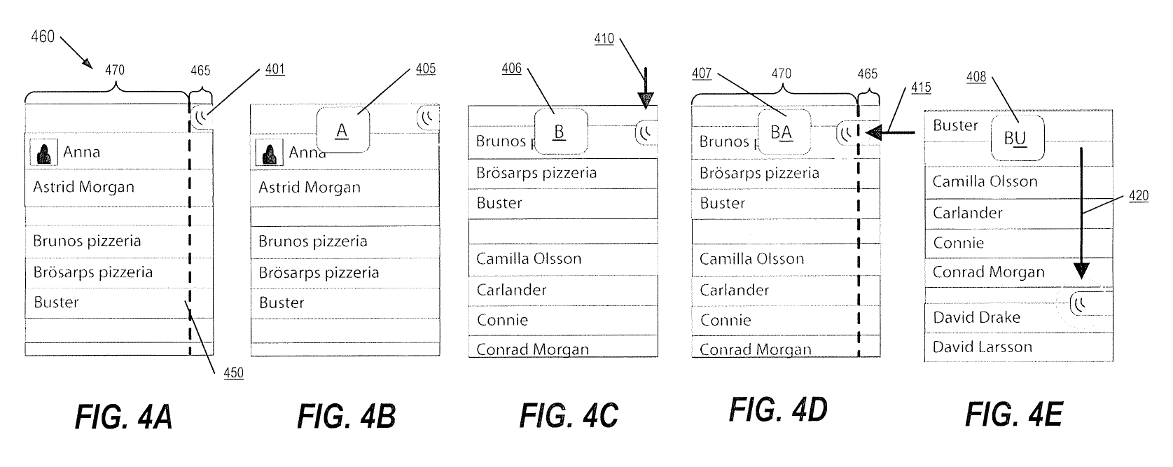

FIGS. 4A to 4E illustrate an example of multi-region touch scrolling on an electronic device including a touch screen 460 having first and second scrolling regions 465 and 470 according to further embodiments of the present invention. The touch screen 460 may be configured to operate and/or may be otherwise similar to the touch screen 360 of FIG. 3A. As shown in FIGS. 4A to 4E, the touch screen 460 displays a contact list 450 having a plurality of entries, including names of people and places or businesses of interest to a user of the device. The first region 465 of the touch screen 460 may have a sensitivity ratio of about 1:1 that associates the scrollable area of the first region 465 with an entirety (e.g. about 100%) of the list 450, while the second region 470 may have a sensitivity ratio of about 10:1 that associates the scrollable area of the second region 470 with a smaller portion (e.g. about 10%) of the list 450.

Referring now to FIG. 4A, a user input object 401 is placed in contact with the first region 465 at a top portion of the touch screen 460. As shown in FIG. 4B, a first letter “A” 405 of one or more of the currently-displayed entries of the list 450 is highlighted in response to detection of the user input object 401 on the surface of the touch screen 460. The user input object 401 is then moved from the top portion of the touch screen 460 in a downward direction toward the bottom portion by a distance 410 in FIG. 4C, defining a scrolling input on the first region 465. The portion of the list 450 including entries that begin with the letter “A” is scrolled across the touch screen 460 in response to detection of the scrolling input at the first region 465 (and based on the distance 410 of the scrolling input in relation to the scrollable length and the sensitivity ratio of the first region 465), such that the portions of the list 450 including entries that begin with the letters “B” and “C” are currently displayed on the touch screen 460. A first letter “B” 406 of one or more of the currently-displayed entries of the list 450 is also highlighted in response to detection of the scrolling input at the first region 465.

Referring now to FIG. 4D, the user input object 401 is moved in a lateral direction from the first region 465 into the immediately adjacent second region 470 by a distance 415 to define a transition input, and a second letter “A” 407 of the currently-displayed entries of the list 450 is highlighted in response to detection of the transition input. As shown in FIG. 4E, the user input object 401 is moved from the top portion of the touch screen 460 in a downward direction toward the bottom portion by a distance 420, defining a scrolling input on the second region 465. The portion of the list 450 including entries that begin with the letter “B” is scrolled across the touch screen 460 in response to detection of the scrolling input at the second region 470 (and based on the distance 420 of the scrolling input in relation to the scrollable length and the sensitivity ratio of the second region 470), such that the portions of the list 450 including entries that begin with the letters “C” and “D” are currently displayed on the touch screen 460. A second letter “U” 408 of one or more of the currently-displayed entries of the list 450 is also highlighted in response to detection of the scrolling input at the second region 470. Accordingly, scrolling inputs received at the first region 465 allow for relatively fast navigation of the list 450 to locate a portion of interest, while scrolling inputs received at the second region 470 allow for more precise navigation of the particular portion of interest in the list 450.

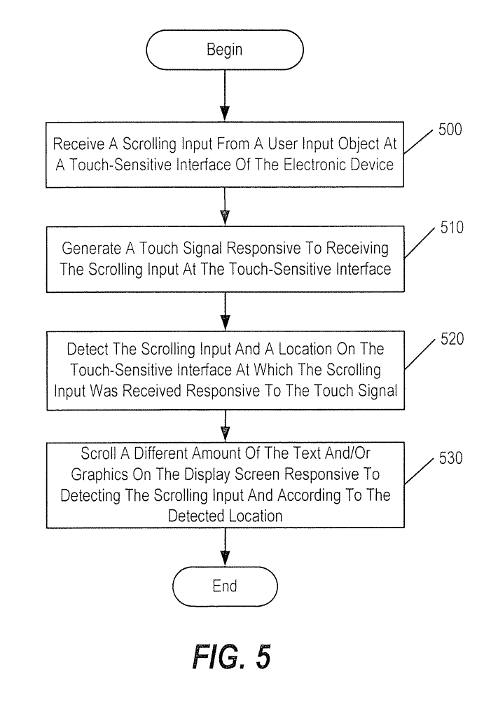

FIG. 5 is a flow diagram illustrating an example control sequence for operating an electronic device, such as any of the electronic devices described above with reference to FIGS. 1-4, to provide multi-region touch scrolling of text and/or graphics on a display screen in accordance with some embodiments of the present invention. Referring now to FIG. 5, operations begin at Block 500 when a scrolling input is received from a user input object at a touch-sensitive interface of the electronic device. A touch signal is generated responsive to receiving the scrolling input at Block 510. The scrolling input, as well as a location on the touch-sensitive interface at which the scrolling input was received, is thereby detected in response to the touch signal at Block 520. For example, the scrolling input may be detected at a first region or a second region of the touch-sensitive interface, each of which may be associated with a different level of sensitivity or responsiveness to the scrolling input. A distance and/or speed of movement of the user input object on the touch-sensitive interface that was used to define the scrolling input may also be detected.

Still referring to FIG. 5, in response to detection of the scrolling input, a different amount of the text and/or graphics is scrolled on the display screen according to the location on the touch-sensitive interface at which the scrolling input was detected at Block 530. In particular, a greater amount of the text and/or graphics may be scrolled responsive to detection of the scrolling input at the first region than at the second region. For example, the first region of the touch-sensitive interface may be associated with a greater percentage of the text and/or graphics than the second region, such that the distance of movement of the user input object on the first region is correlated to a greater portion of the text and/or graphics (and thus, results in a greater amount of scrolling) than a scrolling input of a same distance on the second region. The text and/or graphics may also be scrolled at a greater speed responsive to detection of the of the scrolling input at the first region than at the second region. The speed of scrolling of the text and/or graphics on the display screen may be varied based on the speed of movement of the user input object on the touch-sensitive display, or may be provided at a greater speed when the scrolling input is detected at the first region than when the scrolling input is detected at the second region regardless of the speed of movement of the user input object in some embodiments.

Accordingly, embodiments of the present invention including multiple touch-sensitive regions having different levels of responsiveness to scrolling input may allow for improved scrolling by combining a higher-sensitivity region for faster navigation and a lower-sensitivity region for more precise scrolling. Embodiments of the present invention may be used in any devices that include a touch-sensitive interface, such as personal digital assistants (PDAs), mobile phones, laptop computers, desktop computers, and the like.

Many variations and modifications can be made to the preferred embodiments without substantially departing from the principles of the present invention. All such variations and modifications are intended to be included herein within the scope of the present invention, as set forth in the following claims.

1. An electronic device, comprising:
a user interface comprising a display screen operable to display text and/or graphics and a touch-sensitive interface comprising an array of sensors operable to receive a scrolling input from a user input object and generate a touch signal in response thereto; and
a processor coupled to the user interface and operable to detect the scrolling input and a location on the touch-sensitive interface at which the scrolling input was received responsive to the touch signal, and to scroll a different amount of the text and/or graphics on the display screen responsive to the scrolling input and according to the detected location.

2. The device of claim 1, wherein the touch-sensitive interface comprises first and second regions, wherein the processor is operable to scroll a first amount of the text and/or graphics on the display screen responsive to detection of the scrolling input at the first region, and wherein the processor is operable to scroll a second amount of the text and/or graphics that is less than the first amount on the display screen responsive to detection of the same scrolling input at the second region.

3. The device of claim 2, wherein the processor is operable to detect a distance of movement of the scrolling input on the touch-sensitive interface responsive to the touch signal, to correlate the distance of movement to the first amount of the text and/or graphics according to a first sensitivity ratio responsive to detection of the scrolling input at the first region, and to correlate the distance of movement to the second amount of the text and/or graphics according to a second sensitivity ratio responsive to detection of the same scrolling input at the second region.

4. The device of claim 3, wherein the first sensitivity ratio associates a scrollable area of the first region with a first percentage of the text and/or graphics, and wherein the second sensitivity ratio associates a scrollable area of the second region with a second percentage of the text and/or graphics that is less than the first percentage so that the distance of movement of the scrolling input represents a greater amount of the text and/or graphics responsive to detection thereof at the first region than at the second region.

5. The device of claim 3, wherein the first sensitivity ratio associates a scrollable area of the first region with an entirety of the text and/or graphics, wherein the second sensitivity ratio associates a scrollable area of the second region with a fraction of the text and/or graphics, wherein the processor is operable to scroll less than or up to the entirety of the text and/or graphics responsive to detection of the scrolling input at the first region, and wherein the processor is operable to preclude scrolling of more than the fraction of the text and/or graphics responsive to detection of the same scrolling input at the second region.

6. The device of claim 2, wherein the processor is operable to scroll the first amount of the text and/or graphics on the display screen at a greater scrolling speed than the second amount of the text and/or graphics.

7. The device of claim 2, wherein the text and/or graphics comprises a plurality of alphanumeric entries, and wherein the processor is operable to highlight a first character of one of the plurality of entries that is currently displayed on the display screen responsive to detection of the scrolling input at the first region.

8. The device of claim 7, wherein the processor is operable to detect a transition input indicating movement of the user input object from the first region to the second region responsive to the touch signal, and wherein the processor is operable to highlight on the display screen a second or subsequent character of the displayed one of the plurality of entries responsive to detection of the transition input.

9. The device of claim 8, wherein the processor is operable to scroll only ones of the plurality of entries having the same first character as the displayed one of the plurality of entries responsive to detection of the scrolling input at the second region subsequent to detection of the transition input.

10. The device of claim 2, wherein the second region is immediately adjacent to the first region on the touch-sensitive interface such that the touch-sensitive interface is operable to receive the scrolling input at the first and/or second regions without lifting of the user input object from the touch-sensitive interface.

11. The device of claim 2, wherein the first and second regions comprise different x-coordinates along an x-axis of the touch-sensitive interface so that the first and second regions define first and second columns on the touch-sensitive interface, and wherein the scrolling input comprises substantially similar y-coordinates along a y-axis of the touch sensitive interface within the first or second column.

12. The device of claim 2, wherein the touch sensitive interface further comprises a third region, and wherein the processor is operable to scroll a third amount of the text and/or graphics that is less than the second amount on the display screen responsive to detection of the same scrolling input at the third region.

13. The device of claim 2, wherein ones of the array of sensors underlying the first region are operable to generate a different touch signal responsive to receiving the scrolling input than ones of the array of sensors underlying the second region.

14. The device of claim 2, wherein ones of the array of sensors underlying the first region are greater in number than ones of the array of sensors underlying the second region.

15. The device of claim 1, wherein the display screen is provided underlying the touch sensitive interface such that the user interface comprises a touch screen display.

16. A method of operating an electronic device to control scrolling of text and/or graphics on a display screen thereof, the method comprising:
receiving a scrolling input from a user input object at a touch-sensitive interface of the electronic device;
generating a touch signal responsive to receiving the scrolling input at the touch-sensitive interface;
detecting the scrolling input and a location on the touch-sensitive interface at which the scrolling input was received responsive to the touch signal; and
scrolling a different amount of the text and/or graphics on the display screen responsive to detecting the scrolling input and according to the detected location.

17. The method of claim 16, wherein the touch-sensitive interface comprises first and second regions, and wherein scrolling a different amount of the text and/or graphics comprises:
scrolling a first amount of the text and/or graphics on the display screen responsive to detecting the scrolling input at the first region; and
scrolling a second amount of the text and/or graphics that is less than the first amount on the display screen responsive to detecting the same scrolling input at the second region.

18. The method of claim 17, further comprising:
detecting a distance of movement of the scrolling input on the touch-sensitive interface responsive to the touch signal;
correlating the distance of movement to the first amount of the text and/or graphics according to a first sensitivity ratio responsive to detecting the scrolling input at the first region; and
correlating the distance of movement to the second amount of the text and/or graphics according to a second sensitivity ratio responsive to detecting the same scrolling input at the second region.

19. The method of claim 17, further comprising:
scrolling the first amount of the text and/or graphics on the display screen at a greater scrolling speed than the second amount of the text and/or graphics.

20. A computer program product for operating an electronic device to control scrolling of text and/or graphics on a display screen thereof, the computer program product comprising:
a computer readable storage medium having computer readable program code embodied in said medium, said computer readable program code comprising:
computer readable program code that, when executed, detects a scrolling input from a user input object at a touch-sensitive interface of the electronic device;
computer readable program code that, when executed, generates a touch signal responsive to the scrolling input;
computer readable program code that, when executed, interprets the scrolling input and determines a location on the touch-sensitive interface at which the scrolling input was received responsive to the touch signal; and
computer readable program code that, when executed, scrolls a different amount of the text and/or graphics on the display screen responsive to detecting the scrolling input and according to the detected location.

21. The method of claim 6, wherein the processor is operable to scroll the first and/or second amount of the text and/or graphics on the display screen independent of a speed of the scrolling input.

22. The device of claim 2, wherein the processor is operable to detect the scrolling input as being received at both the first region and the second region of the touch-sensitive interface, and wherein the processor is operable to scroll a third amount of the text and/or graphics responsive thereto.

23. The device of claim 22, wherein the processor is operable to detect the scrolling input as a combination of a first scrolling input received via a first user input object and a second scrolling input received via a second user input object.

24. The device of claim 22, wherein the third amount of text and/or graphics comprises a sum or a product of the first amount and the second amount of the text and/or graphics.

25. The device of claim 22, wherein the processor is operable to scroll the third amount of text at a third scrolling speed, wherein the third scrolling speed comprises a sum or a product of a first scrolling speed associated with the first region and a second scrolling speed associated with the second region.

26. The method of claim 17, wherein detecting the scrolling input comprises detecting the scrolling input as being received at both the first region and the second region of the touch-sensitive interface, and further comprising:
scrolling a third amount of the text and/or graphics responsive to detecting the scrolling input as being received at both the first region and the second region.

27. The method of claim 26, wherein the third amount of text and/or graphics comprises a sum or a product of the first amount and the second amount of the text and/or graphics.

28. The method of claim 26, further comprising:
scrolling the third amount of text at a third scrolling speed, wherein the third scrolling speed comprises a sum or a product of a first scrolling speed associated with the first region and a second scrolling speed associated with the second region.
